(19) United States
(12) Patent Application Publication
(10) Pub. No.: US 2010/0282362 A1
(43) Pub. Date: Nov. 11, 2010

(54) FILL FITTING FOR A FLUID STORAGE TANK

(75) Inventor: Kevin POTTS, Grande Prairie (CA)

Correspondence Address: SHERIDAN ROSS PC, 1560 BROADWAY, SUITE 1200, DENVER, CO, 80202, US

(73) Assignee: MARMIT PLASTICS INC., Grande Prairie (CA)

(21) Appl. No.: 12/760,750

(22) Filed: Apr. 15, 2010

(30) Foreign Application Priority Data
May 7, 2009 (CA) 2665699

(51) Int. Cl. B65B 3/18; F16K 24/04; B65D 85/00

(52) U.S. Cl. 141/44; 141/55; 137/197; 206/216

(57) ABSTRACT

A fitting is provided for attachment to an outlet of a fluid storage tank. The fitting divides the opening into two fluid pathways for independent use in filling and venting of the tank. The fitting prevents spillage and improves site safety at the tank location. The fitting comprises a manifold for attachment to the tank opening, and the manifold is divided into two internal pathways from the tank opening to the exterior environment. A stinger tube is attachable to one of the pathways and extends into the tank to deliver fluid. The stinger includes a siphon break for use in standardizing tank fill levels and in emptying fluid from the manifold to avoid site spillage of tank contents.

### FIELD OF THE INVENTION

The present invention relates generally to the filling and emptying of fluid storage tanks. More particularly, the present invention relates to a device useful in preventing tank overfilling and spillage when adding or removing fluids to/from a storage tank.

### BACKGROUND OF THE INVENTION

Large chemical storage tanks are generally used for containment of industrial process fluids, including water, chemicals, and gases. Many industries use storage tanks only within local plants, while others may store fluids at more remote locations, which may be outdoors. In any application, spillage of fluid and/or direct venting of gases from the tank to ambient air is generally undesirable. Precautions must therefore be taken when connecting lines to the tank, and when filling or emptying the tank, to avoid leaks, spills, and other potentially hazardous site conditions.

Typically, steel tanks have been used to store large volumes of fluid and volatile chemicals. Unfortunately, steel tanks are expensive to manufacture and transport, and are also susceptible to corrosion, with the potential risk of tank failure. Further, steel tanks are typically used with cumbersome fittings and pipes, increasing the cost of transport and the complexity of onsite setup. Often, permanent bracing of the steel tank and associated fill/drain pipes is required, increasing on-site space requirements and limiting the ability to share components between several sites.

Plastic storage tanks are also available. Notable advantages of plastic tanks include seamless construction, rust avoidance, and increased lifespan. Plastic tanks may be of virtually any shape and size, are easily transported, and are produced at lower cost than steel tanks.

Despite the above advantages, care must be taken during use of plastic tanks to avoid excessive internal pressure, and to prevent discharge of static across the surface of the tank, particularly when storing volatile chemicals or venting volatile gas. Workers should not be permitted to crawl, stand, or sit on the top of the tank during use. Accordingly, filling and emptying methods should avoid the need for an individual to climb atop the tank to connect lines and/or view the fluid level.

Accordingly, filling and maintenance methods that address the above-noted issues remotely or from the ground adjacent the tank would be desirable.

### SUMMARY OF THE INVENTION

A fill fitting and filling assembly are provided for use in fluid delivery and removal from a storage tank. Displaced gas and/or fluid is discharged and may be collected to avoid site contamination.

The fitting is secured to an outlet of a fluid storage tank, which may be at any suitable location about the tank. Typically, the tank outlet is located at the top of the tank. Thus, liquid and/or gas displaced during filling of the tank would naturally overflow from the tank outlet when the tank is full or overpressurized.

The present fitting is sealable against the tank outlet directly, or by using an appropriate riser or adapter. The fitting isolates the fluid filling function of the tank outlet from the overflow/discharge function of the outlet by separating the fill pathway from the outflow pathway. In certain applications, the outflow pathway may instead be also used to fill the tank.

In an embodiment, the fitting comprises a unitary manifold having various openings and independent fluid pathways therethrough, for attachment to the tank outlet. These fluid pathways may be of different length, shape, and orientation within the manifold, but provide substantial isolation of each pathway so fluid may be introduced to the tank or withdrawn from the tank without significant disturbance of fluid flowing within the other pathway.

The fluid pathways within the manifold may converge at the tank opening or within the tank. In addition, one or both fluid pathways may be extended within the tank by attachment of a stinger tube.

A stinger tube, if present, will allow delivery/withdrawal of fluid from the bottom of the tank while minimizing turbulence within the tank. The stinger may be provided with one or more apertures or valves along its length to permit mixing of fluids during delivery and withdrawal. The fitting may be used to standardize tank content by preventing overfilling, overpressurization, and/or unwanted mixing of settled fluids.

In a suitable embodiment, each fluid pathway through the manifold terminates proximal to the outlet at a mouth opening. Further, the location, size, and configuration of the mouth openings with respect to the tank outlet may differ, and the location, size and configuration of such mouth openings may be adjustable. For example, one mouth opening may be located within the cross sectional area of the other fluid pathway, and either pathway may be extended by attachment of an extension such as a stinger tube. Thus, in an embodiment, either mouth opening may be adjusted to extend into the storage tank.

Similarly, each fluid pathway opens to the outside of the manifold at an exterior manifold opening. Each exterior manifold opening may be attached to a fluid source or fluid reservoir, for delivering fluid to the tank or receiving displaced fluid from the tank, respectively. In certain applications, it may be desirable to deliver fluid through hose or pipe, and each exterior manifold opening may be adapted for such connection.

In accordance with an aspect of the invention, a fill assembly is described for attachment to an opening of a fluid storage tank, the fill fitting comprising:
a manifold for attachment continuous with a tank opening, the manifold comprising: first and second mouth openings for fluid communication with the tank opening; and first and second independent fluid conduits through the manifold, each fluid conduit continuous with the first or second mouth opening and with respective first and second exterior manifold openings through which fluid may be delivered to or dispensed from the tank via the manifold; and,
a stinger tube for attachment to the first or second mouth opening to extend the first or second fluid conduit through the tank opening and into the tank, the stinger tube comprising a siphon break for use in emptying the manifold after filling of the tank.

The manifold may be made of any suitable material, such as injection molded plastic. The manifold may be threaded for reversible attachment of the stinger. In an embodiment, the stinger is attached to the first or second mouth opening.

In a suitable embodiment, the siphon break is an aperture or check valve along the length of the stinger tube.

In an embodiment, the first exterior manifold opening is adapted for reversible sealing attachment with a fluid source. The fluid source may include, for example, a hose, adapter, fitting, or container for use in storing and delivering the fluid to the exterior manifold opening. In a suitable embodiment, the reversible sealing attachment is provided by a threaded connector or quick connect fitting.

In an embodiment, the stinger tube is operatively attached to the first mouth opening, thereby defining a fill pathway from the fluid source, through the first fluid conduit of the manifold, through the stinger, and into the tank. The first exterior manifold opening may be threaded to a hose in communication with the fluid source to reduce potential for spillage.

In accordance with another aspect, there is provided a fill fitting for attachment to an outlet of a fluid storage tank, the fill fitting comprising a unitary manifold sealable against an outlet of the tank, the manifold comprising: a first mouth opening continuous with the outlet; a second mouth opening continuous with the outlet; and first and second independent fluid conduits through the manifold, each conduit extending from the first or second mouth opening, respectively, to a respective first or second exterior manifold opening, thereby providing first and second independent fluid flowpaths through the manifold to the tank outlet, for use in filling or emptying the tank. The manifold may be made from suitable plastics, for example by injection molding.

In an embodiment, the fitting further comprises a stinger tube attachable to the second mouth opening and extending into the tank.

In a further embodiment, at least a portion of the second fluid conduit is asymmetrical in cross section.

In another embodiment, the first and second flowpaths each define a perpendicular fluid flow path through the manifold.

In a further embodiment, the first and second flowpaths are non-concentric, and a portion of the first flowpath may be adjacent to a portion of the second flowpath. The flowpaths may differ in length, direction, or cross sectional size and shape.

In other embodiments, the first mouth opening is contained within the cross sectional area of the second mouth opening or is proximal to or adjacent to the second mouth opening.

In another embodiment, the first or second mouth opening may be adapted for sealing attachment to the opening of the fluid storage tank.

In accordance with a further aspect, there is provided a kit for use in assembling a fill fitting for attachment to an outlet of a fluid storage tank, the kit comprising:
a manifold for attachment continuous with a tank opening, the manifold comprising: first and second mouth openings for fluid communication with the tank opening; and first and second independent fluid conduits through the manifold, each fluid conduit continuous with the first or second mouth opening and with respective first and second exterior manifold openings through which fluid may be delivered to or dispensed from the tank via the manifold; and,
a stinger tube for attachment to the first or second mouth opening to extend the first or second fluid conduit through the tank opening and into the tank, the stinger tube adaptable for introduction of a siphon break along the length of the stinger tube.

In an embodiment, the siphon break is a one-way valve. The one-way valve may be pre-installed within the stinger tube, or may be installed within the stinger tube on site. If pre-installed, the stinger may be of a greater length than required, such that the stinger may be cut to length on site to appropriately manipulate the location of the siphon break as desired.

In another embodiment, the siphon break comprises one or more apertures within the stinger. The apertures may be pre-drilled, or may be drilled on site. If pre-drilled, the stinger may be of a greater length than required, such that the stinger may be cut to length on site to appropriately manipulate the location of the siphon break as desired.

In a further embodiment, the kit may further comprise an adapter, for attachment to the tank outlet. When installing the adapter on the outlet of a double walled storage tank, the adapted may be installed against the outlet of the tank inner wall. The kit may further comprise a riser for attachment to the adapter such that the manifold may be installed on the riser with the inlet and outlet exterior manifold openings extend past the outer tank wall.

In an embodiment, the stinger is a threaded rod.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Specific embodiments of the present invention will now be described, by way of example only, with reference to the attached Figures, wherein:

FIG. 1 is a perspective cutaway view of a plastic double-walled storage tank and overflow receptacle, with attached fittings and hoses;

FIG. 2a is a top view of a fill fitting in an embodiment;

FIG. 2b is a cross section taken at line A-A of FIG. 1;

FIGS. 2c and d are opposing side views of the fill fitting shown in FIGS. 2A and 2b;

FIGS. 2e and f are perspective views of the fill fitting shown in FIG. 2a-d;

FIG. 3 is a bottom perspective view of a fill fitting, in one embodiment;

FIGS. 4a and 4b and top and bottom schematic representations, respectively, of the fill fitting shown in FIG. 3;

FIG. 4c is a cross sectional schematic view taken along line B-B¹ of FIG. 4a;

FIG. 4d is a side schematic view of the fill fitting shown in FIG. 4a;

FIGS. 5a and 5b are perspective views of a fill fitting in accordance with an embodiment;

FIG. 6 is a vertical cross sectional view of the fitting shown in FIGS. 5a and 5b.

FIG. 7a is a perspective view of an adapter fitting for use in an embodiment; and

FIG. 7b is a cross sectional view of the adapter fitting shown in FIG. 7a.

### DETAILED DESCRIPTION

Generally, the present invention provides a fitting for attachment to a fluid storage tank. The fitting divides a single, circular tank opening into two independent fluid conduits to/from the tank. A method for filling a tank to which the fitting is attached is also described.

### Overview

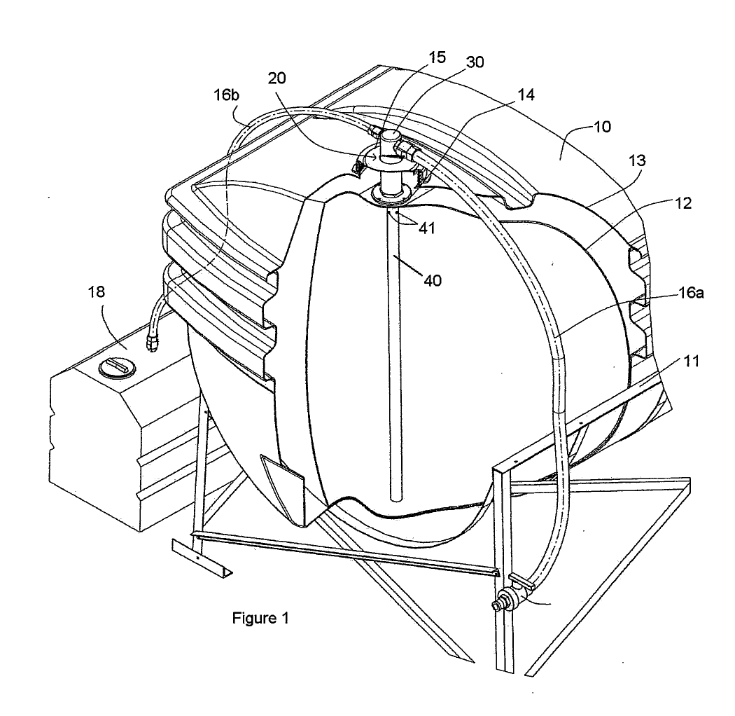

With reference to FIG. 1, a fluid storage tank 10 is shown supported on a stand 11. The tank 10 is double-walled (tank walls 12, 13), and each wall includes an opening 14, 15 to permit filling and emptying of the tank 10. A fill fitting 20 is sealably attached to the inner tank opening 14, and protrudes through the outer tank opening 15.

The manifold 30 of the fill fitting 20 is configured to provide two independent fluid conduits continuous with the tank interior, each extending beyond the tank outer wall 13 so as to be accessible to a user. The fluid conduits exit the manifold 30 on opposing sides at threaded manifold openings 32, 35.

External hoses 16a, 16b, are attached to manifold openings 32 and 35, respectively. Fill hose 16a is mounted to the stand 11 and includes a shutoff valve 17. Overflow hose 16b is continuous with manifold outlet opening 35, and delivers tank overflow fluid to overflow receptacle 18. As shown in FIG. 1, fill hose 16a supplies fluid to the tank through manifold inlet opening 32. Accordingly, fluid enters the manifold at manifold opening 32, flows through the associated independent fluid conduit within the manifold, and arrives and the inner tank opening 14.

A stinger 40, is continuous with the inner tank opening 14 and delivers fluid from the fill hose 16a to the lower portion of the tank. The stinger 40 includes a siphon break, shown in the figures as a series of apertures 41 about the top portion of the stinger. When filling is complete, reversal of flow through the fill hose 16a will empty the tank until the tank fluid level reaches the apertures. At this point air will enter the apertures, breaking the siphon from the stinger to the fill hose and further fluid will not be withdrawn. Thus, the presence of the siphon break serves to standardize fill levels, and will also allow emptying of the fill hose 16a prior to disconnecting from the fluid source, thereby limiting the potential for fill-related site spills. Further, the siphon break will deter attempts to siphon fluid from the tank via the outlet.

In most embodiments, one of the fluid conduits will be used for filling and the other for outflow. The outflow conduit may be used to remove overflow fluid or to vent gas. In some embodiments, the overflow may be attached to a reservoir to contain the overflow or vented gas. Accordingly, chemicals or vented gas may be transferred from one storage container (mobile or stationary) to another using the fitting.

### Manifold

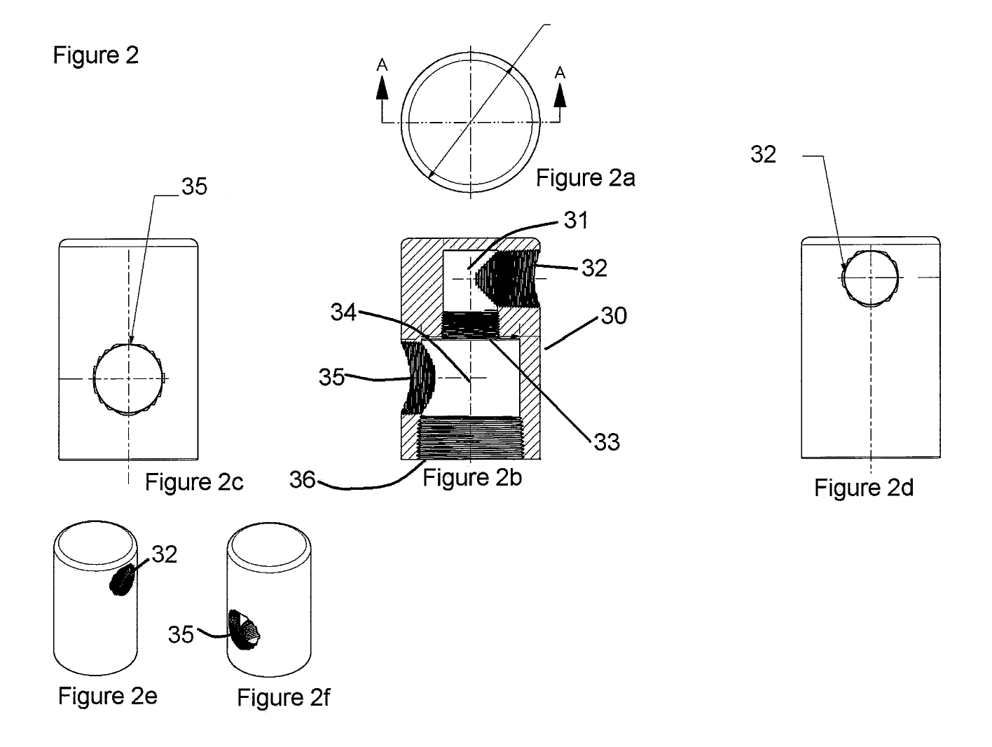

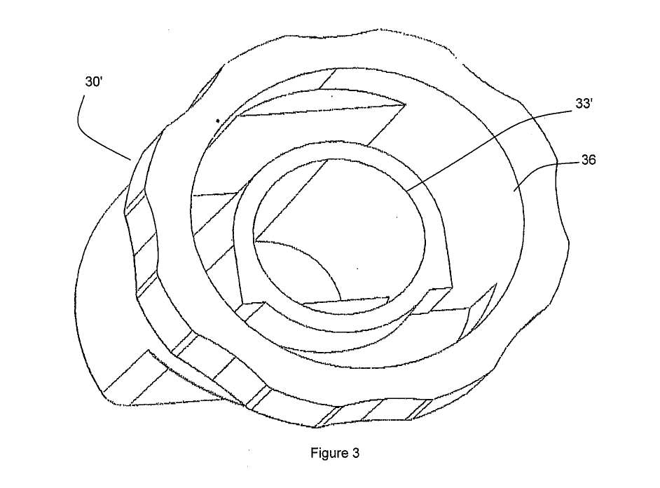

With reference to the embodiment shown in FIG. 2, the plastic manifold 30 is divided into two fluid conduits 31, 34. Fluid conduit 31 will be typically used as the inlet conduit for filling the tank, which is of smaller diameter than outlet conduit 34. Inlet conduit 31 is threaded at the inlet exterior manifold opening 32 for attachment to a fluid supply hose, and is also threaded at the inlet mouth opening 33 for attachment to a stinger extension (not shown).

Similarly, the outlet conduit 34 is threaded at the outlet exterior manifold opening 35 for attachment of an overflow hose or vent fitting as desired (not shown). The base of the manifold, which in this example also forms the outlet mouth opening 36, is threaded for attachment to a tank opening.

With respect to the embodiment shown in FIG. 2, the relative positions of the inlet conduit and outlet conduit (ie. the entire inlet conduit, including exterior manifold opening 32 and inlet mouth opening 33, is positioned above the outlet conduit), inherently seals the independent fluid flow paths from one another in a one-piece unit, without need for additional seals or other onsite assembly of the fitting. That is, the stinger may simply be connected to the inlet mouth opening (if desired) and a supply hose connected to the inlet exterior manifold opening 32 and the tank may be filled. This configuration of fitting may remain indefinitely attached to the tank opening, and accessed using ground level hoses as desired, which may also remain attached between uses for convenience. Accordingly, venting may occur continually, for example as the temperature changes and fluid expands within the tank.

Displaced gas will be vented passively from the tank through exterior manifold opening 35, which may or may not have a hose or vent fitting (of any suitable material) attached thereto. It should be noted that the manifold in this design would be operational even without attachment of a stinger 40 to the inlet mouth opening 33, although in such case a hose or fitting may be attached to the outlet exterior manifold opening 35 as needed, for example to prevent splashing and spillage of fluid therefrom. The inlet mouth opening 33 may instead be offset from the center of the manifold 30 in opposing direction from the outlet manifold opening 35 to further minimize the risk of spillage from the outlet manifold opening 35.

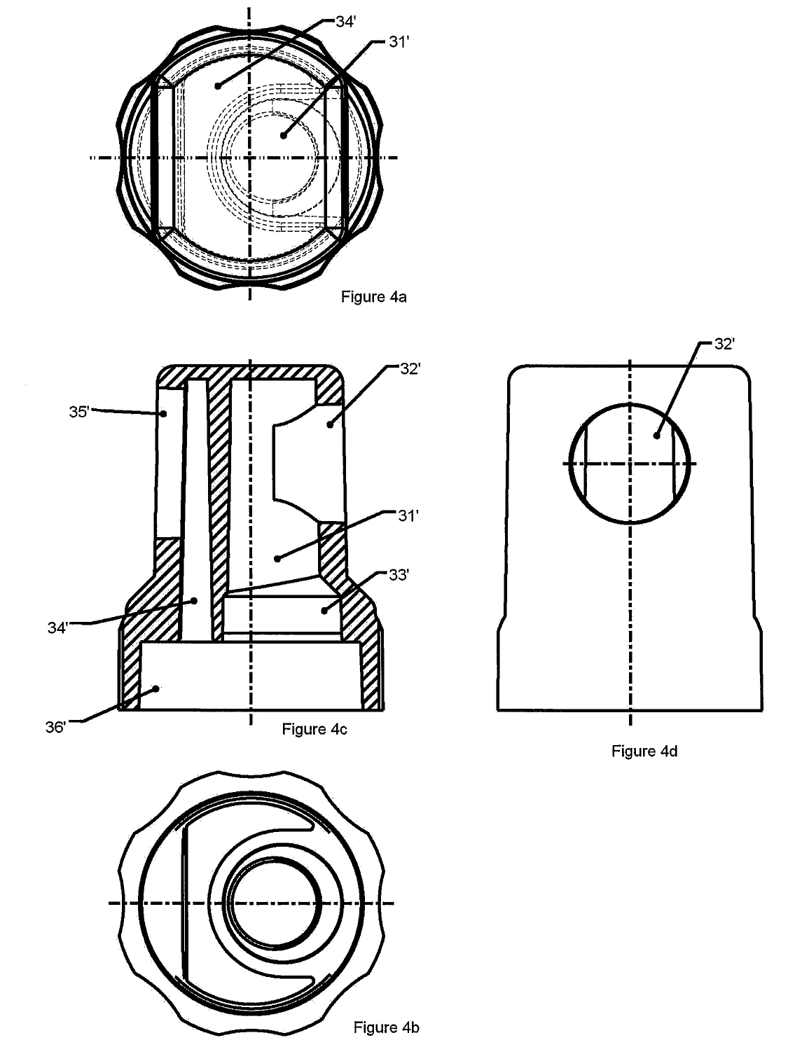

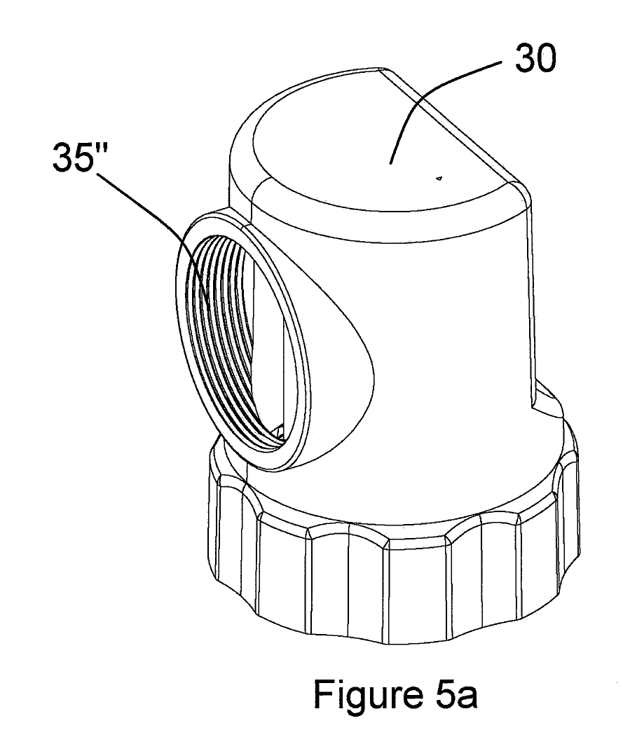

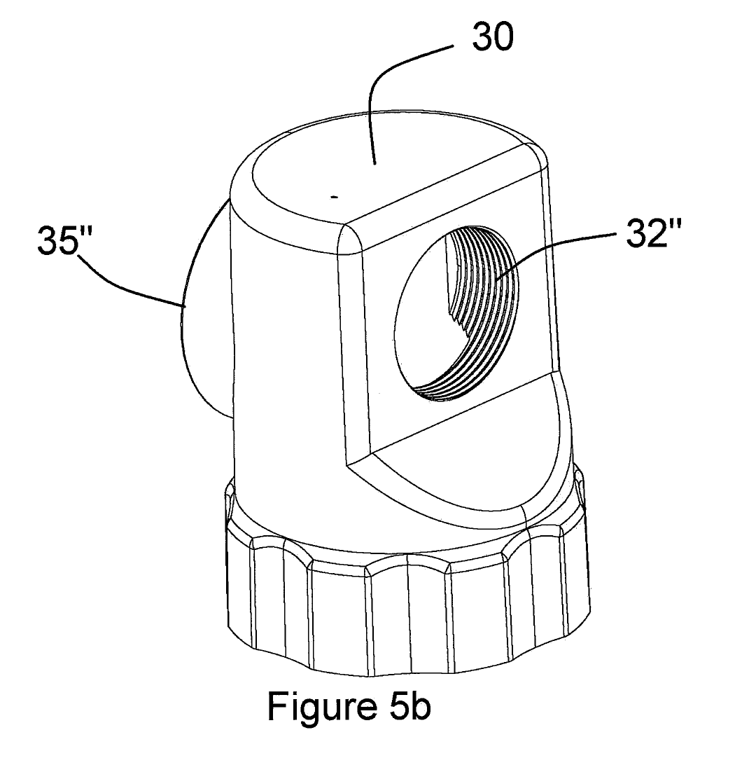

With reference to FIGS. 3 and 4, another suitable manifold design is shown, with similar numbering (eg. manifold 30′) indicating similar components to those previously described. Notably, the independence of the fluid conduits in manifold 30′ is not provided by variation in the height of the exterior manifold conduit openings. Instead, both conduits 31′, 34′, are accommodated within the cross sectional area of the manifold 30′, with exterior manifold openings 32′, 35′ at similar heights from the tank opening. Despite this distinction, the two fluid conduits 31′, 34′ are inherently independent due to the unitary plastic construction of the manifold 30′. Appropriate supply and overflow hoses/fittings may simply be attached to the exterior manifold openings 32′, 35′, and a stinger 40 may be attached to the inlet conduit mouth opening 33′ if desired.

When the exterior manifold openings 31′, 34′ exit horizontally from the manifold as shown in FIGS. 3 and 4, that is at substantially a 90 degree angle from the mouth openings, hoses may be temporarily or permanently attached to each exterior manifold opening 31′, 34′. Such configuration prevents positional crimping of the hoses (as may otherwise occur with a vertical exit from the manifold) and therefore maximizes flow to and from the manifold without need for attachment of additional elbow fittings, etc. to the manifold. Use of flexible hose rather than metal piping to deliver and receive flow to and from the tank is preferred for cost and convenience of setup.

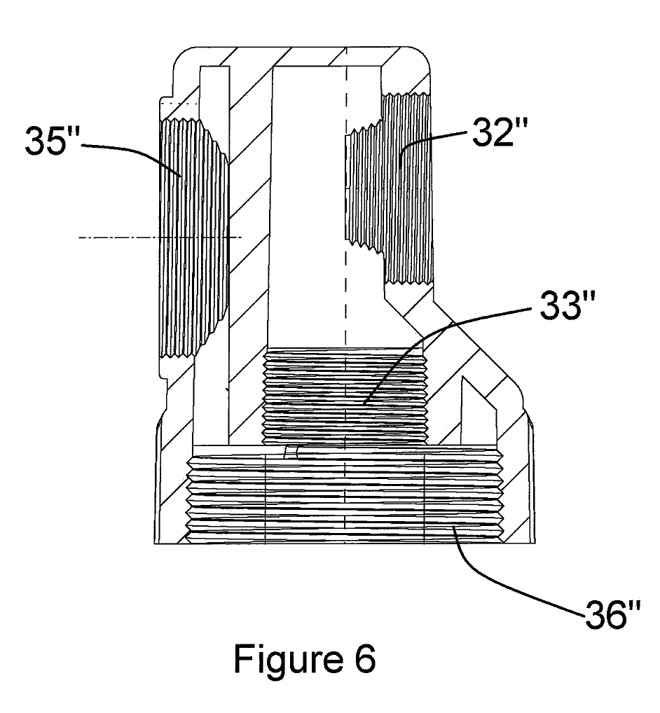

A further embodiment of a suitable fill fitting is shown in FIGS. 5 and 6, in which the inlet conduit and outlet conduit are concentric. Again, like components are denoted with similar reference characters (for example manifold 30″ is similar in function to manifold 30 and manifold 30′ in previously described embodiments).

The fitting shown in the drawings will be typically provided as a unitary plastic component, for example, formed by injection molding. The unitary design simplifies installation and use, and allows the fitting to remain attached to the outlet permanently, if desired.

In any of the designs described above, the exterior outlet opening 35 is larger than the cross section of the inlet conduit to prevent the tank from pressurizing to the point of failure during filling, and similarly to avoid excessive negative pressure during emptying.

### Stinger

A stinger 40, if present, may be attached to the manifold to direct inlet fluid towards the bottom of the tank. This will minimize turbulence within the tank and also minimize the mixing of the incoming fluid with gases that may be present within the upper portion of the tank. Accordingly, gas will generally migrate to the top of the storage tank and is therefore be displaced through the outflow conduit 34 as the tank is filled.

Particular applications may benefit from a stinger of a particular length. Likewise, each tank or each storage situation may have an optimal fluid fill level. A siphon break may be placed along the length of the stinger to facilitate filling or standardizing fill levels. This may be determined by many factors, including the likelihood of fluid volume expansion within the tank, the potential for varying fluid pressures, and the amount and volatility of the gases that may be vented through the manifold. Accordingly, the stinger is preferably detachable and interchangeable from the unitary fitting, to permit specific selection of an appropriate stinger as desired prior to installation and use of the fitting.

In addition to use in standardizing the tank fill level, inclusion of a siphon break 41 within the stinger 40 allows the fill lines to be emptied when filling is complete. The siphon break may simply be one or more apertures within the stinger, or the siphon break may be a one-way valve. Other configurations are also possible.

With reference to FIG. 1, reversal of the pump associated with the filling fluid (for example attached to tap 17), will remove fluid from the storage tank effectively while the siphon break apertures 41 are submerged. Once the tank fluid level reaches the apertures 41, air will enter the stinger via the apertures, and pumping of fluid from the tank via the stinger and inflow conduit will be ineffective. Thus, the siphon effect from the stinger outlet to the tap 17 will be broken. As a result, all fluid within the fill hose 16a will be returned to the supply source attached at tap 17, and all fluid within the manifold 30 and stinger 40 will be returned to the fluid storage tank 10. The fluid supply may then be disconnected from tap 17 without spillage of fluid.

The stinger may be of any suitable material and may be attached to the manifold by any suitable means. For example, the stinger may be threaded to the inlet conduit mouth opening 33. The apertures or other siphon break means may be placed at any suitable location along the stinger 40.

### Adapter

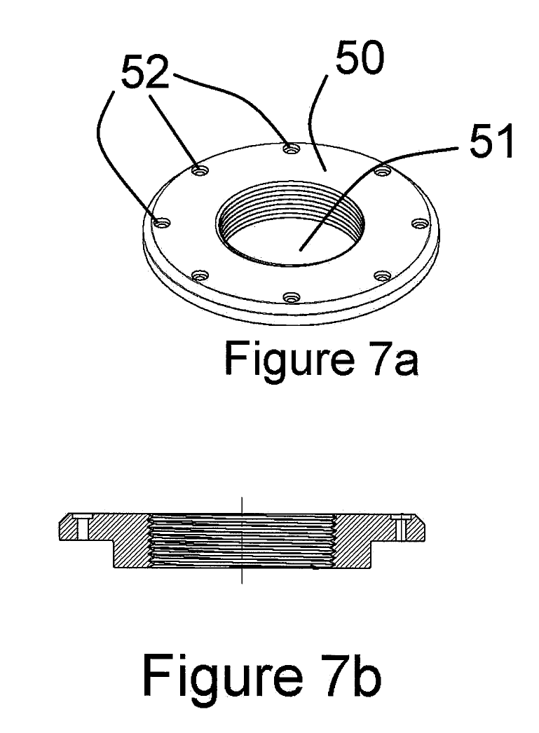

With reference to FIG. 7, an adapter 50 and gasket (not shown) may be used to retrofit a double-walled tank or non-standard opening to receive the manifold 30. The adapter 50 may be made from any suitable material, and is secured to the tank opening as appropriate, for example by welding, or by driving bolts, screws, etc through the securing apertures 52. The central bore 51 of the adapter receives a riser/nipple (not shown) as necessary, to connect the adapter at the tank opening to the manifold 30. When installing on a double-walled tank, the adapter is attached to the inner tank opening 14. A riser, which may simply be a cylinder having appropriate threading at each end, is attached to the adapter. The manifold is attached to the opposing end of the riser, which raises the manifold, allowing the exterior manifold openings 32, 35, to protrude past the outer tank wall 13. In single wall tank retrofit applications, a short riser may instead be used with the adapter to permit attachment of the manifold 30 to the tank opening.

### Method for Filling

Using the presently-described fill fitting, there is minimal need for a worker to climb to the top of the tank during use, filling, or emptying. Further, in double-walled plastic tanks, a sight glass may be present within the wall of the storage tank to allow visualization of the tank fluid level by a worker on the ground. In a single wall tank, no sight glass may be required, as the fluid level is generally visible through the tank wall.

Thus, workers need not breathe fumes associated with gas vented from the tank during filling. Further, the risk of static discharge causing injury or explosion is reduced, in part by avoiding the need to open the tank each time fluid is introduced.

When a new storage site is needed, a tank is placed upon an appropriate support (if required), and the fitting 20 with attached hoses, elbow fittings, taps, etc. are installed while the tank is empty and there is no danger of chemical spill or gas discharge.

When the fluid supply arrives, the contractor or operator may use any appropriate connecting device to access the manifold (hoses or associated accessory fittings) from the ground adjacent the tank. As filling proceeds, the operator views the tank fill level through the side of the tank or sight glass to prevent overfilling. As the tank is filled, gas is displaced from the tank through outflow conduit 34, which may be attached to a reservoir or piping to deliver gas, overflow liquid, and associated fumes, to a safe location.

During filling, care should be taken to introduce fluid slowly so as to avoid the trapping of gas and excessive pressure build-up within the tank, which may lead to tank failure. Generally, the relative sizes of the inflow conduit 31 and outflow conduit 34 (ie. the larger cross sectional area of the outflow conduit) will be sufficient to discharge vent gas and overflow liquid even under fast inflow conditions.

Further, with reference to the design shown in FIG. 2, fluid inlet conduit 31 includes a right angle or elbow, and fluid flow through this portion may become excessively turbulent if fluid is introduced too quickly, causing spillage from the exterior manifold outlet 35. Accordingly, the filling process may differ from one application to the next, depending on the configuration of the fitting, the characteristics of the liquid and the displaced gas, etc.

### Kit

Any number of manifolds, stingers of suitable length(s) and siphon break location(s), and additional fittings, taps, elbows, risers, adapters, etc. may be provided as a kit for use with a fluid storage tank. Specific kits may be assembled and provided for individual applications, such as retrofit, plastic double wall tank, plastic single wall tank, and steel tank applications. Alternatively, a versatile kit may be provided incorporating several versions of each component to ensure ready adaptation to any installation application. For example, such kit may include a riser provided as a long threaded cylinder that is cut to size on site, and similarly a long stinger provided that may be cut to size with siphon break apertures provided or drilled on site.

### Manufacture

The fitting, including the manifold, stinger, adapter, etc. may be made from a wide variety of suitable materials. While fluid storage tank fittings in the prior art have generally been welded and/or machined from a metal manifold, the presently described components are preferably of plastic composition, formed by injection molding or other suitable methods of manufacture. Suitable materials include chemical resistant and/or abrasion resistant polyethylene and polyethylene resins, polypropylenes, composites, glass fiber-reinforced polypropylenes and the like

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A fill assembly for attachment to an opening of a fluid storage tank, the fill fitting comprising:
a manifold for attachment continuous with a tank opening, the manifold comprising: first and second mouth openings for fluid communication with the tank opening; and first and second independent fluid conduits through the manifold, each fluid conduit continuous with the first or second mouth opening and with respective first and second exterior manifold openings through which fluid may be delivered to or dispensed from the tank via the manifold; and,
a stinger tube for attachment to the first or second mouth opening to extend the first or second fluid conduit through the tank opening and into the tank, the stinger tube comprising a siphon break for use in emptying the manifold after filling of the tank.

2. The fill assembly as in claim 1, wherein the manifold is made of plastic.

3. The fill assembly as in claim 1, wherein the stinger tube is detachable from the manifold.

4. The fill assembly as in claim 1, wherein the stinger tube is threadably attached to the first or second mouth opening.

5. The fill assembly as in claim 1, wherein siphon break is an aperture along the length of the stinger tube.

6. The fill assembly as in claim 1, wherein the siphon break is a check valve along the stinger tube.

7. The fill assembly as in claim 1, wherein the first exterior manifold opening is adapted for sealing attachment with a fluid source.

8. The fill assembly as in claim 7, wherein the stinger tube is operatively attached to the first mouth opening, thereby defining a fill pathway from the fluid source, through the first fluid conduit of the manifold, through the stinger, and into the tank.

9. The fill assembly as in claim 8, wherein the first exterior manifold opening is threaded to a hose in communication with the fluid source.

10. A fill fitting for attachment to an outlet of a fluid storage tank, the fill fitting comprising a unitary manifold sealable against an outlet of the tank, the manifold comprising: a first mouth opening continuous with the outlet; a second mouth opening continuous with the outlet; and first and second independent fluid conduits through the manifold, each conduit extending from the first or second mouth opening, respectively, to a respective first or second exterior manifold opening, thereby providing first and second independent fluid flowpaths through the manifold to the tank outlet, for use in filling or emptying the tank.

11. The fitting as in claim 10, wherein the manifold made of plastic.

12. The fitting as in claim 11, wherein the plastic contains polyethylene, polypropylene or polyethylene resin.

13. The fitting as in claim 10, further comprising a stinger tube attachable to the second mouth opening for extending one of the conduits into the tank.

14. The fitting as in claim 10, wherein at least a portion of the first or second fluid conduit is asymmetrical in cross section.

15. The fitting as in claim 10, wherein the fluid conduits each define a perpendicular fluid flow path through the manifold.

16. The fitting as in claim 10, wherein the first and second flowpaths are non-concentric.

17. The fitting as in claim 10, wherein the second mouth opening is contained within the cross sectional area of the first mouth opening.

18. The fitting as in claim 17, wherein the first mouth opening is adapted for sealing attachment to the opening of the fluid storage tank.

19. The fitting as in claim 10, wherein the first mouth opening is adjacent the second mouth opening.

20. A kit for use in assembling a fill fitting for attachment to an outlet of a fluid storage tank, the kit comprising:
a manifold for attachment continuous with a tank opening, the manifold comprising: first and second mouth openings for fluid communication with the tank opening; and first and second independent fluid conduits through the manifold, each fluid conduit continuous with the first or second mouth opening and with respective first and second exterior manifold openings through which fluid may be delivered to or dispensed from the tank via the manifold; and,
a stinger tube for attachment to the first or second mouth opening to extend the first or second fluid conduit through the tank opening and into the tank, the stinger tube adaptable for introduction of a siphon break along the length of the stinger tube.

21. The kit according to claim 20, wherein the siphon break is a one way valve.

22. The kit according to claim 20 wherein the siphon break is an aperture within the stinger.

23. A kit according to claim 20, wherein the storage tank is a double-walled storage tank, and wherein the kit further comprises an adapter for attachment to outlet of the inner wall of the storage tank, the adapter for use in installing the manifold at the tank outlet.

24. A kit according to claim 23, the kit further comprising a rise for attachment to the adapter and to the manifold, to raise the height of the manifold from the tank outlet.

25. The kit as in claim 24, wherein the riser is a threaded rod.
